(19) United States
(12) Patent Application Publication
(10) Pub. No.: US 2008/0030820 A1
(43) Pub. Date: Feb. 7, 2008

(54) Method of Recording a Hologram

(76) Inventors: Satyamoorthy Kabilan, Cambridge (GB); Christopher Creasey, Cambridge (GB)

Correspondence Address: SALIWANCHIK LLOYD & SALIWANCHIK;A PROFESSIONAL ASSOCIATION, PO BOX 142950, GAINESVILLE, FL, 32614-2950, US

(21) Appl. No.: 11/628,683

(22) PCT Filed: May 9, 2006
(86) PCT No.: PCT/GB06/01696

§ 371 Date: Dec. 6, 2006

(30) Foreign Application Priority Data
May 9, 2005 (GB) 0509436.2

(51) Int. Cl. G03H 1/04

(52) U.S. Cl. 359/28

(57) ABSTRACT

A method of recording a master hologram comprises projecting a beam of coherent light, e.g. using a laser (1) through, in turn, a holographic recording medium (8) and a transparent object (22), into a diffuse reflective surface (23), wherein the object is non-holographic and wherein the medium, the object and the surface are in substantially linear arrangement such that light reflected by the surface interferes in the medium with light projected therethrough.

### FIELD OF THE INVENTION

The present invention relates to a method of recording a hologram.

### BACKGROUND TO THE INVENTION

A hologram is essentially a spatial pattern of interference fringes in a medium. Holograms are formed when beams of coherent light constructively interfere in a suitable recording medium, such as a holographic film. Conventional recording processes use two beams of light to record the hologram: the “reference” beam and the “object” beam. The reference beam directly irradiates the recording medium, while the object beam illuminates the object that is being imaged. The object beam is reflected by the object towards the recording medium, where it interferes with the reference beam. The two beams are normally obtained by splitting a single beam of laser light.

“Reflection” holograms are formed when the reference and object beams are projected on opposite sides of the medium. One way in which reflection holograms may be recorded is by an “on-axis” method, in which a single beam is projected through the recording medium onto the object. The beam is then reflected by the object back onto the medium, where it interferes with the reference beam. Alternatively, reflection holograms can be recorded “off-axis”, using separate beams to illuminate the object and the recording medium. These techniques are described in, for example, EP-A-0401566.

The holographic recording of a non-holographic object is referred to as a “master hologram”. For reasons of image quality, master holograms are conventionally recorded as reflection holograms using an off-axis technique. The recording process is complex and lengthy, mainly due to the fact that a split-beam arrangement is used, which can be difficult to balance. There remains a need for a simpler method of recording high-quality master holograms.

### SUMMARY OF THE INVENTION

The present invention is based on the discovery that the above limitations can be overcome by recording master holograms using an on-axis technique in which a diffuse reflector is used. The recording procedure is simplified because only a single beam is used, avoiding the need to split light into, and subsequently balance, reference and object beams. The resulting master hologram is also a colour hologram and can be viewed under white light.

According to the present invention, a method of recording a hologram in a medium comprises projecting a beam of coherent light through, in turn, a holographic recording medium and a transparent object, onto a diffuse reflective surface, wherein the object is non-holographic and wherein the medium, the object and the surface are in a substantially linear arrangement such that light reflected by the surface interferes in the medium with light projected through the medium.

### BRIEF DESCRIPTION OF THE DRAWINGS

FIG. 1 is a schematic diagram of a conventional arrangement for recording a master hologram.

FIG. 2 is a schematic diagram of an arrangement suitable for carrying out a method according to the invention.

### DESCRIPTION OF PREFERRED EMBODIMENTS

The term “master hologram” as used herein refers to a hologram of a non-holographic object.

The term “transparent” as used herein refers to an object comprising one or more regions that can be permeated by light. For example, the object may be a photograph.

The terms “diffuse reflector” and “diffuse reflective surface” as used herein refer to a reflective surface which scatters light in multiple directions. A diffuse reflective effect is obtained when a surface contains irregularities that are large relative to the wavelength of incident light, such that light is reflected in multiple directions.

The diffuse reflective surface is preferably constructed of a non-depolarising material. An example of a diffuse reflective material suitable for use in the invention is aluminium.

Suitable apparatus for carrying out the invention will be apparent to those skilled in the art. The holographic recording medium must be permeable to light, so that light can be projected through it onto the object. Suitable recording media include gelatin and “smart” polymer materials as described in WO95/26499 and WO99/63408.

A method of the invention may be used to produce a holographic sensor. Holographic sensors typically comprise a support medium and, disposed throughout the volume of the medium, a hologram. The support medium interacts with an analyte resulting in a variation of a physical property of the medium. This variation induces a change in an optical characteristic of the holographic element, such as its polarisability, reflectance, refractance or absorbance. If any change occurs whilst the hologram is being replayed by incident broad band, non-ionising electromagnetic radiation, then a colour change may be observed. Holographic sensors are described in, for example, WO95/26499, WO99/63408, WO01/50113, WO03/087899 and WO04/081676, the contents of which are incorporated herein by reference.

The holographic effect may be exhibited by illumination (e.g. under white light, UV or infra-red radiation), specific temperature, magnetic or pressure conditions, or particular chemical, biochemical or biological stimuli. The hologram may be in the form of a pattern which is only visible under magnification.

Holograms produced by a method of the invention may be used to authenticate an article. The sensor may be applied to an article using a transferable holographic film which is, for example, provided on a hot stamping tape. The article may be a transaction card, banknote, passport, identification card, smart card, driving licence, share certificate, bond, cheque, cheque card, tax banderole, gift voucher, postage stamp, rail or air ticket, telephone card, lottery card, event ticket, credit or debit card, business card, or an item used in consumer, brand and product protection for the purpose of distinguishing genuine products from counterfeit products and identifying stolen products. The holograms may be used to provide product and pack information for intelligent packaging applications. “Intelligent packaging” refers to a system that comprises part of, or an attachment to, a container, wrapper or enclosure, to monitor, indicate or test product information or quality or environmental conditions that will affect product quality, shelf life or safety and typical applications, such as indicators showing time-temperature, freshness, moisture, alcohol, gas, physical damage and the like.

Alternatively, the holograms can be applied to products with a decorative element or application such as any industrial or handicraft item including but not limited to items of jewelry, items of clothing (including footwear), fabric, furniture, toys, gifts, household items (including crockery and glassware), architecture (including glass, tile, paint, metals, bricks, ceramics, wood, plastics and other internal and external installations), art (including pictures, sculpture, pottery and light installations), stationery (including greetings cards, letterheads and promotional material) and sporting goods.

The invention is particularly relevant to a diagnostic device such as a test strip, chip, cartridge, swab, tube, pipette or any form of liquid sampling or testing device, and products or processes relating to human or veterinary prognostics, theranostics, diagnostics or medicines. The sensors may be used in a contact lens, sub-conjuctival implant, sub-dermal implant, test strip, chip, cartridge, swab, tube, breathalyser, catheter, any form or blood, urine or body fluid sampling or analysis device. The sensors may also be used in a product or process relating to petrochemical and chemical analysis and testing, for example in a testing device such as a test strip, chip, cartridge, swab, tube, pipette or any form of liquid sampling or analysis device.

The invention will now be described with reference to the accompanying drawings, which are intended for the purposes of illustration only.

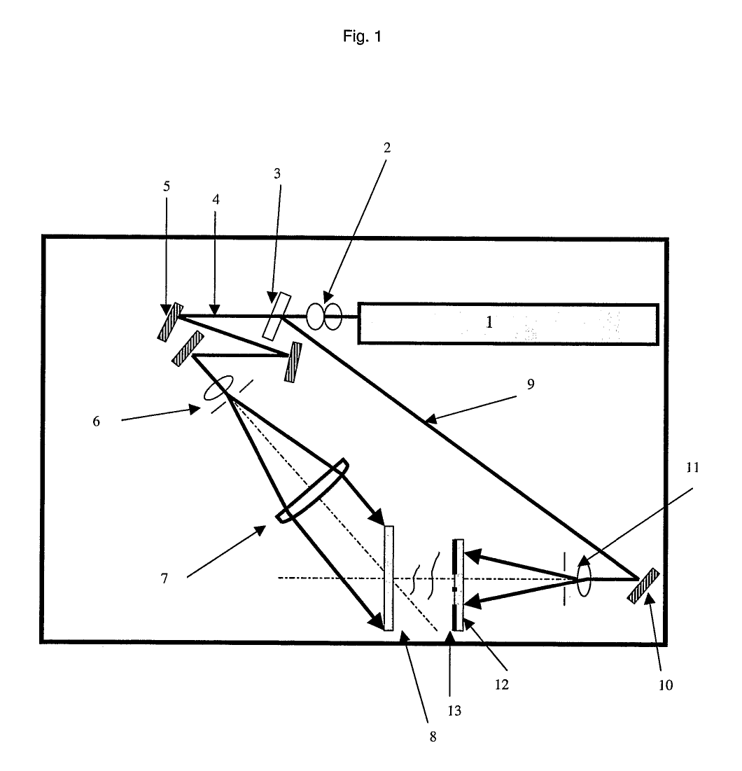

FIG. 1 depicts a conventional “off-axis” arrangement for recording a master hologram. Light emitted by laser 1 passes through beam axis translation mirrors 2 and is split into by two beams by beam-splitter 3. Beam 4 (the reference beam) is guided via a series of mirrors 5, spatial filter 6 and lens 7, to recording medium 8. Beam 9 (the object beam) is directed by mirror 10 and spatial filter 11 to the object 12, which is held in place by registration plate 13. Light reflects from the object and interferes with the reference beam, forming a reflection hologram in the medium.

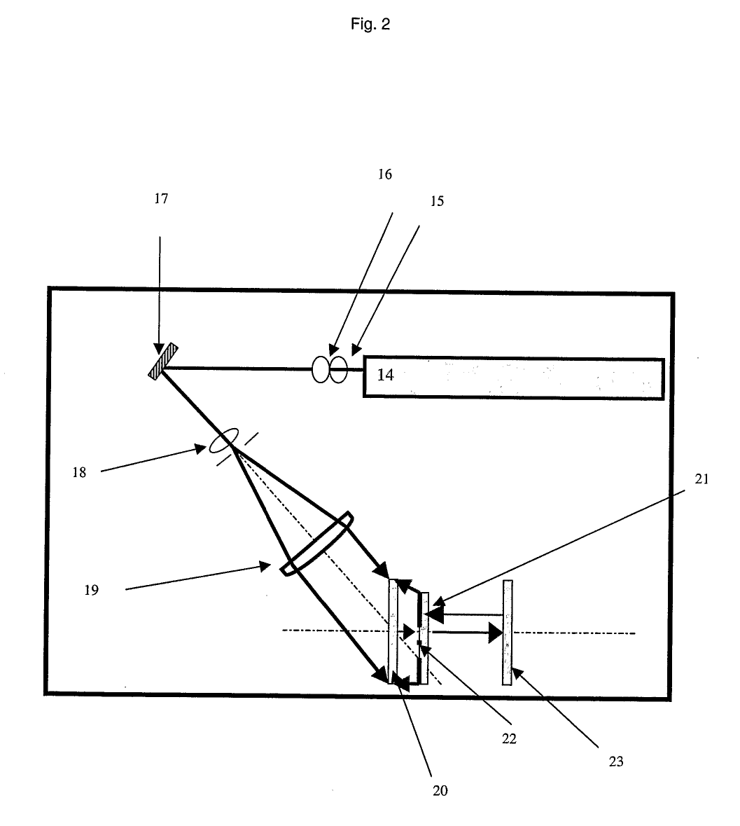

FIG. 2 depicts an arrangement suitable for carrying out a method of the invention. Laser 14 emits a beam of light 15, which passes through beam axis translation mirrors 16. The beam is guided via mirror 17, spatial filter 18 and lens 19, to recording medium 20. The beam passes through the recording medium and object 21, which is held in place by registration plate 22 at a fixed distance from diffuse reflector 23. The object is typically a photograph or other artwork comprising one or more transparent (i.e. light permeable) regions. The recording medium, object and reflector are in a linear arrangement so that light is reflected back through the object towards the recording medium, where it interferes with light projected through the medium. By varying the separation between the object and the reflector, the virtual depth of the holographic image can be controlled.

1. A method of recording a master hologram in a medium, which comprises projecting a beam of coherent light through, in turn, a holographic recording medium and a transparent object, onto a diffuse reflective surface, wherein the object is non-holographic and wherein the medium, the object and the surface are arranged along the path of the light beam such that light reflected by the surface interferes in the medium with light projected therethrough.

2. The method according to claim 1, wherein the light is laser light.

3. The method according to claim 1, wherein the object is a photograph.

4. The method according to claim 1, wherein the surface is constructed of non-depolarising material.

5. The method according to claim 1, wherein the surface is an aluminium surface.

6. The method according to claim 1, wherein the hologram is generated by the diffraction of light.

7. The method according to claim 1, wherein the hologram is only visible under magnification.

8. The method according to claim 1, wherein the holographic image is of an object or is a 2- or 3-dimensional effect.

9. The method according to claim 1, further comprising the introduction of means for producing an interference effect when illuminated with laser light.

10. The method according to claim 9, wherein the means comprises a depolarising layer.

11. The method according to claim 1, wherein the hologram is viewable under white light, UV light or infra-red radiation.

12. The method according to claim 1, wherein the hologram is viewable under specific temperature, magnetism or pressure conditions.

13. An article comprising a master hologram obtained by a method which comprises projecting a beam of coherent light through, in turn, a holographic recording medium and a transparent object, onto a diffuse reflective surface, wherein the object is non-holographic and wherein the medium, the object and the surface are arranged along the path of the light beam such that light reflected by the surface interferes in the medium with light projected therethrough.

14. The article according to claim 13, which is a transaction card; banknote; passport; identification card; smart card; driving licence; share certificate; bond; cheque; cheque card; tax banderole; gift voucher; postage stamp; rail or air ticket; telephone card; lottery card; event ticket; credit or debit card; business card; or an item used in consumer, brand or product protection for the purpose of distinguishing genuine products from counterfeit products or identifying stolen products.

15. The article according to claim 13, which is an item of intelligent packaging.

16. The article according to claim 13, which is an industrial or handicraft item comprising a decorative element, selected from items of jewelry, items of clothing, fabric, furniture, toys, gifts, household items, architecture, art, stationary and sporting goods.

17. The article according to claim 13, which is a product or device for use in agricultural studies, environmental studies, human or veterinary prognostics, theranostics, diagnostics, therapy or chemical analysis.

18. The article according to claim 17, which is a test strip, chip, cartridge, swab, tube, pipette, contact lens, sub-conjuctival implant, sub-dermal implant, breathalyser, catheter or a fluid sampling or analysis device.

19. A transferable holographic film comprising a master hologram obtained by a method which comprises projecting a beam of coherent light through, in turn, a holographic recording medium and a transparent object, onto a diffuse reflective surface, wherein the object is non-holographic and wherein the medium, the object and the surface are arranged along the path of the light beam such that light reflected by the surface interferes in the medium with light projected therethrough.

20. The film according to claim 19, which is present on a hot stamping tape.

21. A method of enhancing the security of an article, which comprises transferring onto the article a transferable holographic film comprising a master hologram obtained by a method which comprises projecting a beam of coherent light through, in turn, a holographic recording medium and a transparent object, onto a diffuse reflective surface, wherein the object is non-holographic and wherein the medium, the object and the surface are arranged along the path of the light beam such that light reflected by the surface interferes in the medium with light projected therethrough.

22. A product comprising a master hologram obtained by a method, which comprises projecting a beam of coherent light through, in turn, a holographic recording medium and a transparent object, onto a diffuse reflective surface, wherein the object is non-holographic and wherein the medium, the object and the surface are arranged along the path of the light beam such that light reflected by the surface interferes in the medium with light projected therethrough, wherein said product is capable of generating data from said master hologram.

23. A system which uses data generated by a product comprising a master hologram obtained by a method which comprises projecting a beam of coherent light through, in turn, a holographic recording medium and a transparent object, onto a diffuse reflective surface, wherein the object is non-holographic and wherein the medium, the object and the surface are arranged along the path of the light beam such that light reflected by the surface interferes in the medium with light projected therethrough wherein said product is capable of generating data from said master hologram, wherein said system utilizes said generated data for data storage, control, transmission, reporting and/or modelling.
